(19) United States
(12) Patent Application Publication
(10) Pub. No.: US 2003/0232119 A1
(43) Pub. Date: Dec. 18, 2003

(54) Method of preparation of sweet microwave popcorn

(76) Inventor: Vladi Krumov Popov, Montreal (CA)

Correspondence Address: Vladi Popov, 37 , poruchik Dimitar Velichkov,, Plovdiv, 2000, BG

(21) Appl. No.: 10/171,241

(22) Filed: Jun. 14, 2002

(51) Int. Cl. A23L 1/168

(52) U.S. Cl. 426/618

(57) ABSTRACT

The method of preparation of sweet microwave pop-corn guarantees a finished product, where the presence of sugar does not harden the popcorn and they remain white and tender, without burn over the pack and among the popped kernels inside, homogeneously colored and flavoured, with natural ingredients. This method starts with the preparation of a sugar—glucose syrup made of sugar, water and glucose. The mixture is heated and cooled up to determinate temperature. The next mixture is a fat solution consisted of coconut or palm oil, lecithin and cream or flavouring. The final mixture is made of corn, sugar-glucose syrup and the fat solution. Flavouring like caramel or chocolate and colouring can be added to the sugar-glucose syrup. One of the following ingredients can be added: peanuts, hazelnuts, walnuts, almonds, a caramel or chocolate flavouring.

### BACKGROUND OF THE INVENTION

Microwave pop-corn is a semi-cooked type of food popular among people. Offering a wide range of tastes of this product also provokes interest in it.

Sweet microwave pop-corn is examined in patents U.S. Pat. No. 5,443,858, AU 1097595, EP 0727946. It is known that in the preparation is used a mixture of non-popped corn, a sweetening mixture and glaze. To obtain these components are used the following initial products: oil ingredient, crystal sugar, maize suryp, sodium chloride, granulated sugar, vanilla, caramel, lecithin, gnanulated honey. The weight percents can vary as follows: non-popped corn 48+55, sweetening mixture—fine granulated sugar 14+21, granulated brown sugar 10, granulated honey 4, oil 23+30, vanilla 1, caramel 0.7, maize syrup 42+43, lecithin 0.5+0.55.

Sweet microwave pop-corn U.S. Pat. No. 4,904,488 is known as a product where taste is given by a caramel flavouring, containing maize syrup, sugar, milk, maltosadextrine, partial hydrogenized coconut oil, salt, natural and artificial flavourings and colour mixture.

In major cases the additional flavouring mixture is poured over the hot popcorn and the mixture in the packet is well stirred after that. In such a case a homogeneous colour and flavourring cannot be obtained.

A natural harmony in the taste quality of the product cannot be obtained in the above-mentioned types of microwave popcorn because of the use essentially of artificially-obtained substances.

### SUMMARY OF THE INVENTION

To overcome these problems and to avoid the hardness of the popcorn and the burn provoked by the presence of sugar is created a sweet popcorn product for microwaves with different kinds of flavour like cream, caramel, chocolate, with nuts, homogeneously coloured and flavoured. Their ingredients are the following: corn, oil, cream, lecithin, sugar, water, glucose, essence, flavouring. According to the invention igredients as initial products are in the following quantities and weight percents: corn 55+65,/coconut or palm/oil 18+25, cream 0.10+0.15/or essence/, lecithin 0.05+0.10, sugar 11+15, water 3.5+3.7, glucose 6+10 and flavouring. The flavouring can be a kind of caramel flavouring, which is 13% of the total mixture and 20%+50% of the sugar-glucose syrup/sugar, water, glucose/and containing sugar in weight percents in the flavouring between 82 and 97, cacao ot chocolate powder between 3 and 12 and colour between 0.3 and 1.2 weight percents of the total mass of the product. The flavourings can be replaced by one of the following products, which are between 6 and 15 weight percents: nuts/peanuts, hazelnuts, walnuts, almonds/which may be combined with both sweet popcorn with cream and popcorn with caramel and chocolate.

To obtain the microwave corn a preliminary treatment, mixing and packing should be effectuated.

During the preliminary treatment is effectuated the following: separate weighing of the ingredients, according to the recipe, the oil is melt at a temperature of approximately 50° C.

Mixing:

1-st Stage—Preparation of the Sugar-Glucose Syrup.

Sugar and water/already weighed/are mixed and heated at a temperature of 105° C. A determined quantity of glucose is poured over the homogeneous mixture and thus the obtained solution is heated up to 112° C.

The obtained sugar-glucose syrup is taken away from the heating source and is cooled down to approximately 50° C.

2-nd Stage—Preparation of the Fat Solution.

The previously weighed lecithin and cream/essence/are poured in the melt oil and is stirred until a homogeneous mixture is obtained.

Flavouring like peanuts, hazelnuts, walnuts, almonds are additioned to the fat solution, if our desire is to prepare microwave popcorn garnished with nuts.

3-rd Stage—The Prepared Sugar-Glucose Syrup in the First Stage is Poured in the Fat Solution of the 2-nd Stage. The Mixture is Stirred Well.

To the solution is additioned the weighed quantity of corn and the process of stirring continues until a homogeneous mixture is obtained.

The preparation of caramel of chocolate microwave pop-corn is effectuated when the caramel or chocolate flavouring is poured into the sugar-glucose syrup. It is subsequently stirred until a homogeneous mixture is obtained. The 2-nd and the 3-rd stage are the same.

Packing: the obtained homogeneous mass of the mixture is weighed for every pack, oil-resisting one-, bi- or tri-layer paper packs or with the appropriate polyethilen for food are filled in with it, the packs are closed after all the necessary information for the product is noted down on them, the closure in an individual cellophane pack finalizes the operation.

The advantages of this kind of microwave pop-corn are:

The presence of sugar does not give hardness to the corn, they remain white and tender and no burn on top of the package and the pop-corn is noticed.

A homogeneous colouring of the finished product is attained for all of its ingredients, even the flavouring and the cream/essence/are additioned in the melt oil and stirred.

A homogeneous flavouring of the finished product for its entire mass in one pack is attained, for all of its ingredients are additioned to the melt fat mass when stirring.

In the finished product are used only natural and ecologic products.

The increase of the varieties of this product by adapting it to the preferences of more consumers, the attainment of an exceptional cream taste.

### EXAMPLES FOR REALIZATION

### Example 1

Sweet microwave pop-corn with cream. The microwave pop-corn in a quantity of 1000 gr. include the following ingredients as initial products:

| | | |
|---|---|---|
| Popocorn kernels | 600 | gr. |
| Coconut or palm oil | 200 | gr. |
| Sugar | 130 | gr. |
| Glucose | 80 | gr. |
| Water | 36 | ml. |
| Lecithin | 0.5 | gr. |
| Cream or flavouring | 1.3 | ml. |

The sum of the above-mentioned ingredients is not equal to 1000 gr. It is always superior because of the evaporation process when reaching the boiling point.

### Example 2

Microwave pop-corn with caramel flavouring

The microwave pop-corn in a quantity of 1000 gr. Include the following ingredients as initial products:

| | | |
|---|---|---|
| Popcorn kernels | 521 | gr. |
| Coconut or palm oil | 166 | gr. |
| Sugar | 117 | gr. |
| Glucose | 80 | gr. |
| Water | 32.4 | ml. |
| Lecithin | 0.5 | gr. |
| Caramel flavouring: | | |
| sugar | 93 | gr. |
| cacao /chocolate/ powder | 32 | gr. |
| Flavouring | 1.3 | ml. |

The sum of the above-mentioned ingredients is not equal to 1000 gr. It is always superior because of the evaporation process when reaching the boiling point.

### Example 3

Sweet microwave pop-corn with cream, garnished with peanuts.

The microwave pop-corn in a quantity of 1000 gr. include the following ingredients as initial products:

| | | |
|---|---|---|
| Popcorn kernels | 513 | gr. |
| Coconut or palm oil | 178 | gr. |
| Sugar | 130 | gr. |
| Glucose | 80 | gr. |
| Water | 36 | ml. |
| Almonds | 109 | gr. |
| Lecithin | 0.5 | gr. |
| Cream or flavouring | 1.3 | ml. |

The sum of the above-mentioned ingredients is not equal to 1000 gr. It is always superior because of the evaporation process when reaching the boiling point.

### Example 4

Microwave pop-corn with caramel flavouring and nuts.

The microwave pop-corn in a quantity of 1000 gr. include the following ingredients as initial products:

| | | |
|---|---|---|
| Popcorn kernels | 485 | gr. |
| Coconut or palm oil | 151 | gr. |
| Sugar | 117 | gr. |
| Glucose | 71 | gr. |
| Water | 32.4 | ml. |
| Almonds, nuts | 82 | gr. |
| Lecithin | 0.5 | gr. |
| Caramel flavouring: | | |
| Sugar | 79 | gr. |
| cacao powder | 24 | gr. |
| Flavouring | 1.3 | ml. |

The sum of the above-mentioned ingredients is not equal to 1000 gr. It is always superior because of the evaporation process when reaching the boiling point.

### Example 5

Microwave pop-corn with chocolate flavouring and nuts.

The microwave pop-corn in a quantity of 1000 gr. include the following ingredients as initial products:

| | | |
|---|---|---|
| Popcorn kernels | 481 | gr. |
| Coconut or palm oil | 149 | gr. |
| Sugar | 112 | gr. |
| Glucose | 71 | gr. |
| Water | 31.4 | ml. |
| Peanuts | 101 | gr. |
| Lecithin | 0.5 | gr. |
| Chocolate flavouring: | | |
| - sugar | 75 | gr. |
| - chocolate | 21 | gr. |
| Flavouring | 1.2 | ml. |

The sum of the above-mentioned ingredients is not equal to 1000 gr. It is always superior because of the evaporation process when reaching the boiling point.

We claim:

1. Method of preparation of sweet microwave pop-corn, consisting in the mixing by stages of the popcorn kernels, oil, sugar, glucose, water, lecithin, flavourings, characteristic with the preparation of:
sugar-glucose syrup from sugar 11 to 15 weight percents and water 3.5 to 3.7 weight percents, heated up to 105° C., glucose 6 to 10 weight percents is added and the mixture is heated up to 112° C.,the whole mixture is cooled down under 50° C.;
an fat solution of coconut or palm oil 18 to 25 weight percents, lecithin 0.5 to 0.10 weight percents;
final fixture made of popcorn kernels 55 to 65 weight percents, sugar-clucose syrup and the fat solution.

2. Method of preparation of sweet microwave pop-corn, according to claim 1, characteristic with the adding of flavouring to the sugar-glucose syrup of the species caramel or chocolate flavouring in weight percents 13, containing sugar in weight percents 82 to 97, cacao or chocolate powder 3 to 12 weight percents and colouring 0.3 to 1.2 weight percents.

3. Method of preparation of sweet microwave pop-corn, according to claim 1, characteristic with the adding of one of the following ingredients in the fat solution, which are 6 to 15 weight percents: peanuts, hazelnuts, walnuts, almonds, there may be caramel or chocolate flavouring 0.5 to 5 weight percents.
